(19) United States
(12) Patent Application Publication
(10) Pub. No.: US 2008/0120318 A1
(43) Pub. Date: May 22, 2008

(54) Device, Method and Computer Program Product for Information Retrieval

(76) Inventor: Shmuel Zailer, Herzlia (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/562,019

(22) Filed: Nov. 21, 2006

(51) Int. Cl. G06F 17/30

(52) U.S. Cl. 707/102; 707/E17.044

(57) ABSTRACT

A system, method and computer product for information retrieval. The method includes: generating a control data structure representative of multiple information items that were journaled from a group of tables to a group of journal receivers; wherein the journal data structure comprises association information that associates between different table representations of a certain information item; receiving a request to retrieve a journaled information item; and retrieving the journaled information item in response to content of at least one entry of the control data structure.

### FIELD OF THE INVENTION

The present invention relates to a method, a system and a computer program product for information retrieval.

### BACKGROUND

Various databases include multiple tables. Each table includes information items that are used by a single application. Changes in each table are logged by a process known as journaling. During a journal operation, changed information from a table is sent to a journal receiver. The journal receiver usually includes journaled information as well as journal meta-data that define the time of change.

The following U.S. patents and patent applications, all being incorporated herein by reference, illustrate systems and methods for journaling information: U.S patent application publication serial number 2006/149798 of Yamagami, U.S patent application publication serial number 2006/149792 of Yamagami, and U.S. Pat. No. 7,010,721 of Vincent.

Certain processes, especially complex processes, are managed by executing multiple applications. These applications can use different data structures and their tables can include different fields. Furthermore, a single information item (also referred to as logical information item), can be represented in different manners in different tables. For example, the names of the fields that represent the information item, the length of these representations and their location can differ from one table to another.

For example, assuming that a certain hospital uses a first application to keep track of surgical proceedings executed by its staff, a second application to keep track of the prescriptions written by its staff and a third application to keep track of the patients being examined by its staff. The information relating to each application is stored in a different table, and different journal receivers store journaled information generated by different applications. Thus, if a manager wishes to determine the activities of a certain staff member on a certain day (participated in a surgical procedure, dispensed prescriptions and examined a number of patients), the manager will have to manually combine information from different applications.

There is a growing need to provide efficient process-monitoring tools, especially process-monitoring tools based upon efficient retrieval of journaled information.

### SUMMARY OF THE PRESENT INVENTION

A computer program product of a computer readable medium usable with a programmable computer, the computer program product having computer-readable code embodied therein for retrieving information, the computer-readable code includes instructions for: (i) generating a control data structure representative of multiple information items that were journaled from a group of tables to a group of journal receivers; wherein the journal data structure comprises association information that associates between different table representations of a certain information item; (ii) receiving a request to retrieve a journaled information item; and (iii) retrieving the journaled information item in response a content of at least one entry of the control data structure.

A method for information retrieval, the method includes: (i) generating a control data structure representative of multiple information items that were journaled from a group of tables to a group of journal receivers; wherein the journal data structure includes association information that associates between different table representations of a certain information item; (ii) receiving a request to retrieve a journaled information item; and (iii) retrieving the journaled information item in response to content of at least one entry of the control data structure.

A system for information retrieval, the system includes: a group of journal receivers, at least one journal container and a journal controller. The journal controller is adapted to: (i) generate a control data structure representative of multiple information items that were journaled from a group of tables to the group of journal receivers, (ii) receive a request to retrieve a journaled information item, and (iii) retrieve the journaled information item in response to content of at least one entry of the control data structure. The journal data structure includes association information that associates between different table representations of a certain information item.

### BRIEF DESCRIPTION OF THE DRAWINGS

The present invention will be understood and appreciated more fully from the following detailed descriptions taken in conjunction with the drawings in which:

FIG. 1 illustrates a system, according to an embodiment of the invention;

FIG. 2 illustrates a first data structure, according to an embodiment of the invention; and

FIG. 3 illustrates a method for information retrieval, according to another embodiment of the invention.

### DETAILED DESCRIPTION

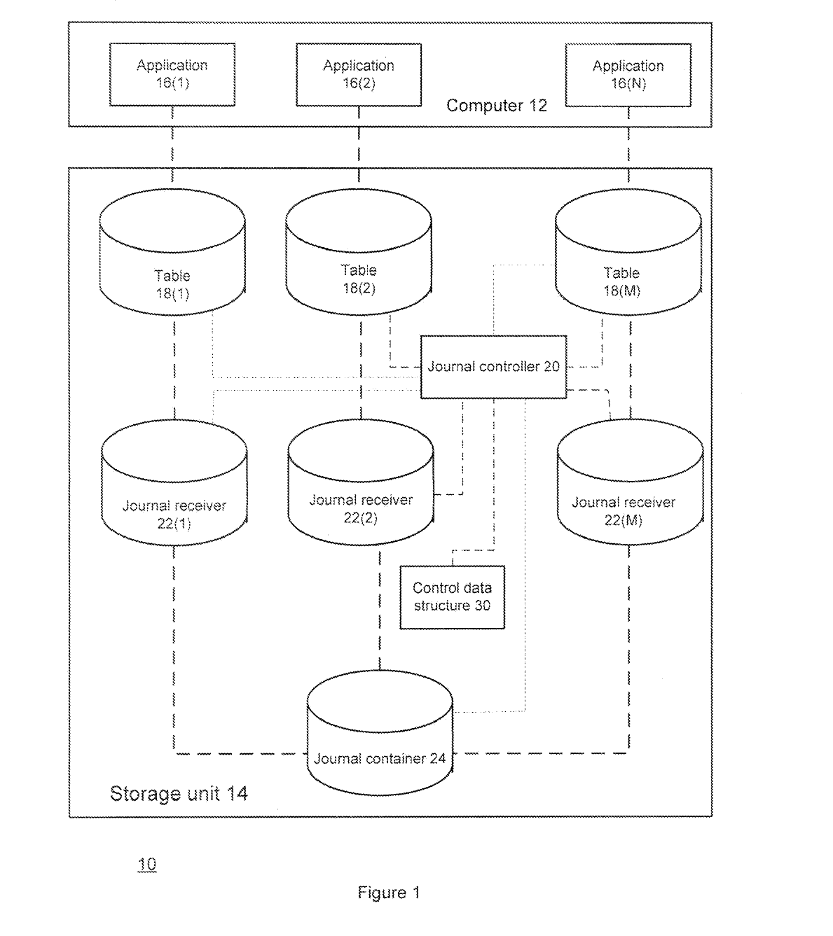

FIG. 1 illustrates system 10 for information retrieval, according to an embodiment of the invention.

System 10 includes a computer such as host computer 12 and a storage unit 14. The storage unit 14 can be integrated with host computer 12, but this is not necessarily so. Host computer 12 can be located at a first location while storage unit 14 can be located at another remote location.

Host computer 12 executes multiple applications (denoted 16(1)-16(N)). The information of each application can be stored in a dedicated table out of group of tables 18. Group of tables 18 includes tables 18(1)-18(M). It is noted that the number of applications (N) can differ from the number of tables (M), although this is not necessarily so and N may equal M.

Group of tables 18 includes at least two tables that differ from each other. Typically, tables 18(1)-18(M) differ from each other.

At least one information item (also referred to as logical information item) is represented in two or more different manners in group of tables 18.

Journal controller 20 monitors changes in the content of tables 18(1)-18(M) and applies a journal process when it detects a change. It is noted that journal controller 20 can ignore some changes, according to predefined journal rules.

Journal controller 20 can access journal receivers 22(1)-22(M). Each table is associated with a journal receiver. Journal controller 20 sends journaled information from table 18(m) to a corresponding journal receiver 22(m). Journal controller 20 also generates journal meta-data that can describe the journal operation (for example the time of the journal operation) or the journaled information (for example—address, length, and the like).

Journal controller 20 is also adapted to control the provision of journaled information from the journal receivers to one or more journal containers, such as journal container 24.

Journal container 24 can store journaled information but can also store control data structure 30. Control data structure 30 can be used to selectively prevent journaled information from being stored at journal container 24. Control data structure 30 can be scanned, and alternatively or additionally, be indexed, in order to retrieve journaled information in a highly efficient manner.

Control data structure 30 is representative of multiple information items that were journaled from group of tables 18 to a group of journal receivers 22. Journal data structure 30 includes association information that associates between different table representations of a certain information item.

Conveniently, at least one of the fields of control data structure 30 is a field of a table representation of an information item.

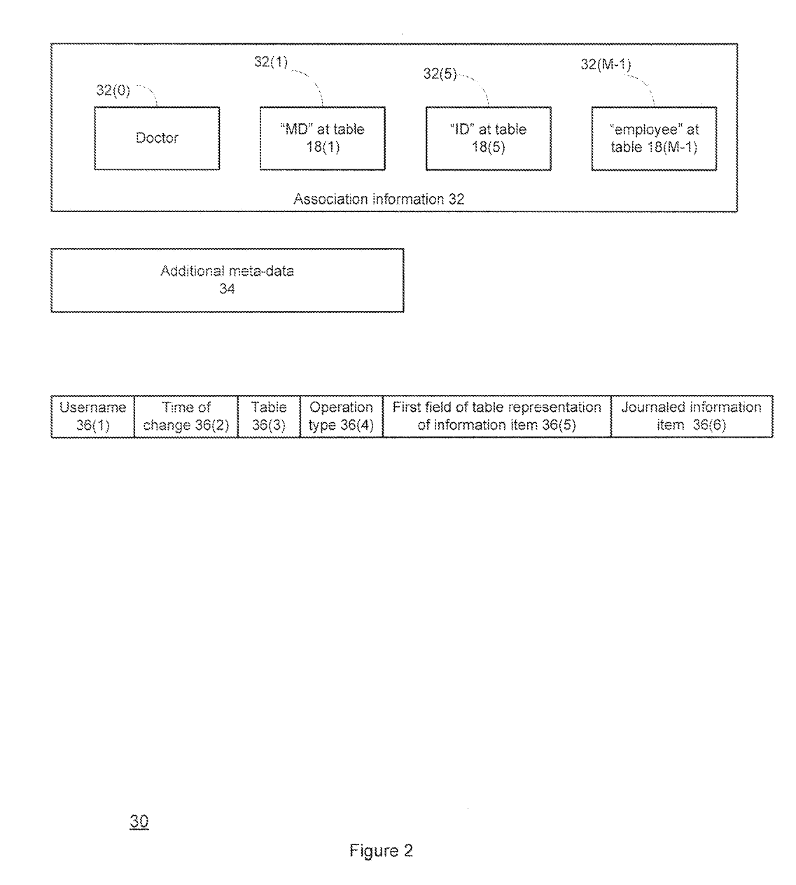

FIG. 2 illustrates control data structure 30 according to an embodiment of the invention.

Control data structure 30 includes association information 32 that may include multiple fields for each information item of interest. For example, association information fields 32(0)-32(M) can associate between a certain information item (32(0)) and multiple representations of that information item at tables 18(1)-18(M). For example, if a doctor is represented by field “MD” in table 18(1), by field “ID” in table 18(5) and by field “employee” in table 18(M-1) then association information 32 will indicate that a doctor's name (field 32(0)) is represented by these fields (MD, ID and employee), as illustrated by the content of fields 32(1)-32(3). A certain doctor (For example Doctor_X) will be represented by certain values of fields MD, ID and employee. If the values are the same that value can be searched when information relating to that doctor is requested. If different values of these fields represent the same doctor a mapping between the different is also provided.

The association information can also indicate the location and/or length of each field in each table (for example—address, offset from table start address, end address, and the like).

Control data structure 30 can include meta-data fields (such as fields 34) that are scanned during journaled information retrieval. Thus, if a request to retrieve information associated with Doctor_X is received by system 10, meta-data fields 34 can be scanned in order to determine which journalized information items to provide.

It is further noted that a control data structure can include (or can be) an indexed data structure that can be indexed by various indexes, and that one or more fields of a table representation of an information item can be used as an index. For example, the indexed data structure can include a “Doctor_X” entry that will indicate where journalized information related to Doctor_X can be found. Yet in another example, the indexed data structure can include a combination of the value for field “MD” and the value for field “ID”.

Conveniently, control data structure 30 also includes a log of the journal operations, as illustrated by fields 36(1)-36(6). It is noted that field 36(6) represents the journaled information item and that this field can be stored outside the control data structure. Fields 36(1)-36(5) provide an example of a journaled information item header. These fields can be scanned during data retrieval. It is noted that although a single field (field 36(5)) is a taken from the table representation of the information item (for example it can be any field from amongst “MD”, “ID” or “employee”, the header can include more than a single table representation field.

Field 36(1) indicates the username of the user who caused the journal operation. Field 36(2) indicates the time of the journal operation. Field 36(3) indicates the table from which the information item was journaled. Field 36(4) indicates the type of operation that triggered the journal operation.

It is noted that each journal operation, or at least each journal operation that complies with predefined journal rules, can be represented by fields 36(1)-36(6). It is further noted that other fields can replace fields 36(1)-36(5).

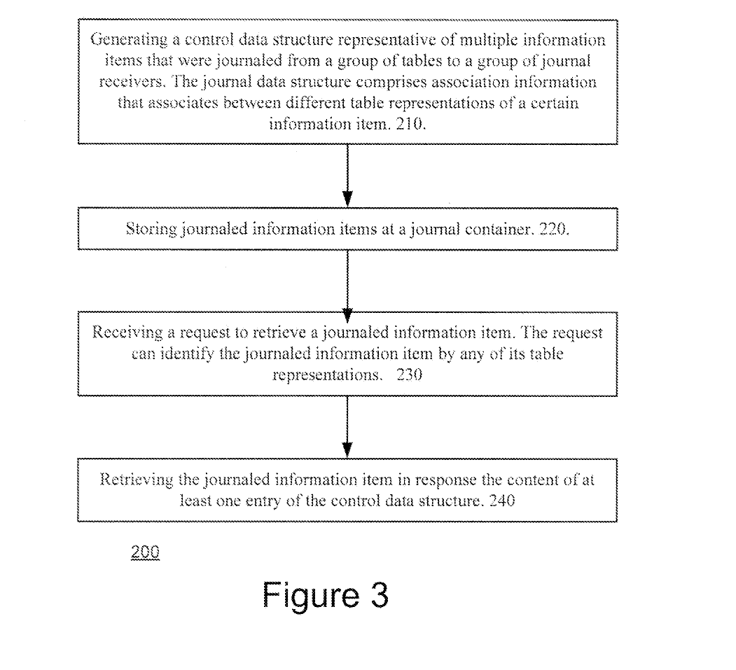

FIG. 3 illustrates method 200 for information retrieval according to an embodiment of the invention.

Method 200 starts by stage 210 generating a control data structure representative of multiple information items that were journaled from a group of tables to a group of journal receivers. The journal data structure comprises association information that associates between different table representations of a certain information item.

Stage 210 includes defining the structure of the control data structure as well as updating the content of the control data structure when information items are journaled.

Conveniently, stage 210 includes defining a control data structure field as a field of a table representation of an information item. Thus, for example, a control data structure entry can include at least one of the following fields: “MD”, “ID” or “employee”. This enables scanning this field and not scanning the journaled information.

Stage 210 is followed by stage 220 for storing journaled information items in a journal container. Stage 220 can include filtering journaled information items and storing filtered journaled information items in the journal container.

Stage 220 is followed by stage 230 for receiving a request to retrieve a journaled information item. The request can identify the journaled information item by any of its table representations.

Stage 230 is followed by stage 240 for retrieving the journaled information item in response to the content of at least one entry of the control data structure. Stage 240 can include scanning the control data structure. According to an embodiment of the invention the control information is an indexed control data structure. The indexed control data structure can be generated, at least partially, while information items are journaled. If an indexed control data structure exists, stage 240 can include using the request (or at least a portion of the request) as an index to the indexed data structure.

It is further noted that the control data structure can include an indexed portion and a non-indexed portion. Both portions can be searched in order to locate one or more journaled information item.

According to yet another embodiment of the invention, method 200 includes generating an alert when a certain information item is journaled. The alert criteria can be stored in the control data structure.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

What is claimed is:

1. A method for information retrieval, comprising generating a control data structure representative of multiple information items that were journaled from a group of tables to a group of journal receivers; wherein the journal data structure comprises association information that associates between different table representations of a certain information item; receiving a request to retrieve a journaled information item; and retrieving the journaled information item in response to content of at least one entry of the control data structure.

2. The method according to claim 1, wherein generating comprises defining a control data structure field as a field of a table representation of an information item.

3. The method according to claim 1, wherein generating comprises defining multiple control data structure fields as multiple fields of a table representation of an information item.

4. The method according to claim 1, wherein generating is followed by storing journaled information items in a journal container.

5. The method according to claim 4, further comprising filtering journaled information items and storing filtered journaled information items in the journal container.

6. The method according to claim 1, wherein generating comprises generating an indexed control data structure.

7. The method according to claim 6, wherein the indexed control data structure is indexed by fields of table representations of information items.

8. The method according to claim 1, wherein retrieving the journaled information item comprises scanning the control data structure.

9. A system for information retrieval, comprising a group of journal receivers, at least one journal container and a journal controller adapted to generate a control data structure representative of multiple information items that were journaled from a group of tables to the group of journal receivers; wherein the journal data structure comprises association information that associates between different table representations of a certain information item; wherein the journal controller is adapted to receive a request to retrieve a journaled information item; and to retrieve the journaled information item in response to content of at least one entry of the control data structure.

10. The system according to claim 9, wherein the journal controller is adapted to store journaled information items in the journal container.

11. The system according to claim 10, wherein the journal controller is further adapted to filter journaled information items and store filtered journaled information items in the journal container.

12. The system according to claim 9, wherein the journal controller is adapted to generate an indexed control data structure.

13. The system according to claim 12, wherein the journal controller is adapted to access the control data structure by using an index that comprises at least one field of a table representation of information items.

14. The system according to claim 9, wherein the journal controller is adapted to scan the control data structure.

15. A computer program product of a computer readable medium usable with a programmable computer, the computer program product having computer-readable code embodied therein for retrieving information, the computer-readable code comprising instructions for generating a control data structure representative of multiple information items that were journaled from a group of tables to a group of journal receivers; wherein the journal data structure comprises association information that associates between different table representations of a certain information item; receiving a request to retrieve a journaled information item; and retrieving the journaled information item in response a content of at least one entry of the control data structure.

16. The computer program product of claim 15, wherein the computer-readable code embodied therein further comprises instructions for defining a control data structure field as a field of a table representation of an information item.

17. The computer program product of claim 15, wherein the computer-readable code embodied therein further comprises instructions for defining multiple control data structure fields as multiple fields of a table representation of an information item.

18. The computer program product of claim 15, wherein the computer-readable code embodied therein further comprises instructions for storing journaled information items at a journal container.

19. The computer program product of claim 15, wherein the computer-readable code embodied therein further comprises instructions for filtering journaled information items and storing filtered journaled information items in the journal container.

20. The computer program product of claim 15, wherein the computer-readable code embodied therein further comprises instructions for generating an indexed control data structure.
